(19) United States
(12) Patent Application Publication
(10) Pub. No.: US 2025/0079103 A1
(43) Pub. Date: Mar. 6, 2025

(54) DIKE AS EPOXY SQUEEZE OUT BARRIER IN FUSE DEVICES

(71) Applicant: Littelfuse, Inc., Chicago, IL (US)

(72) Inventors: Lily Rosios, Malvar Batangas (PH); Roel Retardo, Malvar Batangas (PH); Lowel Pia, Malvar Batangas (PH)

(73) Assignee: Littelfuse, Inc., Chicago, IL (US)

(21) Appl. No.: 18/819,127

(22) Filed: Aug. 29, 2024

Related U.S. Application Data
(60) Provisional application No. 63/535,266, filed on Aug. 29, 2023.

(51) Int. Cl. H01H 85/00; H01H 69/02

(52) U.S. Cl. CPC H01H 85/0013; H01H 69/02; H01H 2211/004; H01H 2229/002; H01H 2229/056

(57) ABSTRACT

A dike as an epoxy squeeze out barrier in a fuse device is provided. The fuse device can include first and second layers of laminate material, a cavity formed by central openings of the first and second layers of the laminate material, a fuse element that is supported by at least one of the first and second layers of the laminate material and traverses the cavity, an adhesive located on at least one of the first and second layers of the laminate material for bonding thereof, and a dike located on at least one of the first and second layers of the laminate material and surrounding a circumference of the cavity. When the first and second layers of the laminate material, the fuse element, the adhesive, and the dike are pressed together during manufacture, the dike can prevent the adhesive from flowing into the cavity.

### CROSS-REFERENCE TO RELATED APPLICATIONS

This application claims the benefit of priority to U.S. Provisional Patent Application No. 63/535,266, filed Aug. 29, 2023, entitled “DIKE AS EPOXY SQUEEZE OUT BARRIER IN FUSE DEVICES,” which is incorporated herein by reference in its entirety.

### FIELD

The present disclosure generally relates to fuse devices. More particularly, the present disclosure relates to a dike as an epoxy squeeze out barrier in fuse devices.

### BACKGROUND

Many fuse devices use epoxy or another adhesive to bond layers thereof. However, when the layers of the fuse devices and the epoxy are pressed together during manufacture, the epoxy can squeeze out from between the layers, which can cause operational problems. For example, as seen in FIG. 1, in a fuse device that includes a laminate material 102, such as FR4, with a cavity 106 for a fuse element, such as a wire-in-air (WIA), the epoxy 104 can be placed on top of, below, and/or in between layers of the laminate material 102 for bonding thereof. However, when the layers of the laminate material 102 and the epoxy 104 are pressed together during manufacture, the epoxy 104 can squeeze out from between the layers of the laminate material 102 and into the cavity 106, as shown by the arrows in FIG. 1 designating the flow of the epoxy 104.

Such squeeze out can cause restrike failure during a short circuit event and/or product reliability issues. Indeed, when the epoxy 104 seeps into the cavity 106, the epoxy can come into contact with the fuse element, thereby causing element corrosion. Furthermore, when the epoxy 104 seeps into the cavity 106, an effective volume of the cavity 106 for the fuse element can be reduced, thereby leading to nuisance openings. Any time the epoxy 104 seeps into the cavity 106, energy loss that can lead to overload failures as a result of the fuse element not meeting required opening time criteria can occur and/or a current overload or a short circuit failure due to a burned fuse can occur. In this regard, heat coming from a current overload or a short circuit event that is used to melt the fuse element and enact fuse functionality can be lost through dissipation or by altering ideal conditions that promote or favor enhanced functionality, such as, for example, the effective volume of the cavity 106.

In view of the above, there is a continuing, ongoing need for an apparatus and a method to prevent epoxy squeeze out in fuse devices.

### BRIEF SUMMARY

This Brief Summary is provided to introduce a selection of concepts in a simplified form that are further described below in the Detailed Description. This Brief Summary is not intended to identify key features or essential features of claimed subject matter or intended as an aid in determining scope of the claimed subject matter.

In some embodiments, an apparatus in accordance with the present disclosure can include a first layer of laminate material, a second layer of the laminate material, a cavity formed by central openings of the first layer of the laminate material and the second layer of the laminate material, a fuse element that is supported by at least one of the first layer of the laminate material and the second layer of the laminate material and traverses the cavity, an adhesive located on at least one of the first layer of the laminate material and the second layer of the laminate material for bonding thereof, and a dike located on at least one of the first layer of the laminate material and the second layer of the laminate material and surrounding a circumference of the cavity. When the first layer of the laminate material, the second layer of the laminate material, the fuse element, the adhesive, and the dike are pressed together during manufacture, the dike can prevent the adhesive from flowing into the cavity.

In some embodiments, the dike can include a non-conductive material.

In some embodiments, the dike can include a photo-imageable material, a liquid photo-imageable ink, a film, a coating, or a mask.

In some embodiments, the adhesive can flow away from the cavity and the dike when the first layer of the laminate material, the second layer of the laminate material, the fuse element, the adhesive, and the dike are pressed together during manufacture.

In some embodiments, the dike can include a slot or a canal on opposing ends of the dike for holding or guiding the fuse element.

In some embodiments, the apparatus can include a clearance between the adhesive and the dike or between the cavity and the dike.

In some embodiments, the adhesive material can spread into the clearance when the first layer of the laminate material, the second layer of the laminate material, the fuse element, the adhesive, and the dike are pressed together during manufacture.

In some embodiments, a method in accordance with the present disclosure can includes supporting a fuse element by at least one of a first layer of laminate material or a second layer of the laminate material with the fuse element traversing a cavity formed by central openings of the first layer of the laminate material and the second layer of the laminate material, forming a dike on at least one of the first layer of the laminate material or the second layer of the laminate material between the first layer of the laminate material and the second layer of the laminate material with the dike surrounding the cavity, bonding the first layer of the laminate material and the second layer of the laminate material with an adhesive located on at least one of the first layer of the laminate material and the second layer of the laminate material, pressing the first layer of the laminate material, the second layer of the laminate material, the fuse element, the adhesive, and the dike together during manufacture, and preventing the adhesive from flowing into the cavity with the dike.

In some embodiments, the method can include flowing the adhesive away from the cavity and the dike.

In some embodiments, the method can include holding or guiding the fuse element with a slot or a canal on opposing ends of the dike.

In some embodiments, the method can include spreading the adhesive material into a clearance between the adhesive and the dike or between the cavity and the dike.

In some embodiments, the method can include lowering an original thickness of the dike or the adhesive material to a reduced thickness.

In some embodiments, the method can include placing a photo-imageable film on at least one of the first layer of the laminate material or the second layer of the laminate material, placing a transparent film with an artwork pattern on the photo-imageable film, exposing the artwork pattern to cure a portion of the photo-imageable film underneath the transparent film, removing the transparent film, and dissolving uncured portions of the photo-imageable film while leaving the portion of the photo-imageable film that was cured to create the dike.

In some embodiments, the method can include spraying a liquid photo-imageable ink (LPI) on at least one of the first layer of the laminate material or the second layer of the laminate material, placing a transparent film with an artwork pattern on the LPI, exposing the artwork pattern to cure a portion of the LPI underneath the transparent film, removing the transparent film, and dissolving uncured portions of the LPI while leaving the portion of the LPI that was cured to create the dike.

In some embodiments, the method can include curing the LPI at low temperatures to partially dry the LPI prior to placing the transparent film on the LPI.

In some embodiments, the method can include placing a screen print or a stencil on at least one of the first layer of the laminate material or the second layer of the laminate material, depositing a liquid photo-imageable ink (LPI) on the screen print or the stencil with the LPI seeping through an aperture of the screen print or the stencil and onto at least one of the first layer of the laminate material or the second layer of the laminate material, removing the screen print or the stencil, and curing the LPI on the first layer of the laminate material or the second layer of the laminate material to create the dike.

In some embodiments, an apparatus can include a layer of laminate material, a cavity formed by an internal cut-out of the layer of the laminate material, an adhesive located on the layer of the laminate material, and a dike located on the layer of the laminate material and surrounding a circumference of the cavity. The dike can control a flow of the adhesive.

In some embodiments, the dike can include a slot or a canal on opposing ends of the dike.

In some embodiments, the apparatus can include a clearance between the adhesive and the dike or between the cavity and the dike.

In some embodiments, when the layer of the laminate material, the adhesive, and the dike are pressed together during manufacture, the dike can prevent the adhesive from flowing into the cavity.

Other technical features may be readily apparent to one skilled in the art from the following figures, descriptions, and claims.

### BRIEF DESCRIPTION OF THE SEVERAL VIEWS OF THE DRAWINGS

FIG. 1 is a cross-sectional side view illustrating a fuse device known in the art.

FIG. 2A is a cross-sectional top view illustrating a fuse device in accordance with disclosed embodiments.

FIG. 2B is a cross-sectional side view illustrating a fuse device along cross-section A of FIG. 2A in accordance with disclosed embodiments.

FIG. 2C is a cross-sectional side view illustrating a fuse device along cross-section B of FIG. 2A in accordance with disclosed embodiments.

FIG. 3A is an exploded view illustrating a fuse device in accordance with disclosed embodiments.

FIG. 3B is an exploded view illustrating a fuse device in accordance with disclosed embodiments.

FIG. 4 is a cross-sectional top view illustrating a fuse device in accordance with disclosed embodiments.

FIG. 5 is a flow diagram illustrating a method in accordance with disclosed embodiments.

FIG. 6 is a flow diagram illustrating a method in accordance with disclosed embodiments.

FIG. 7 is a flow diagram illustrating a method in accordance with disclosed embodiments.

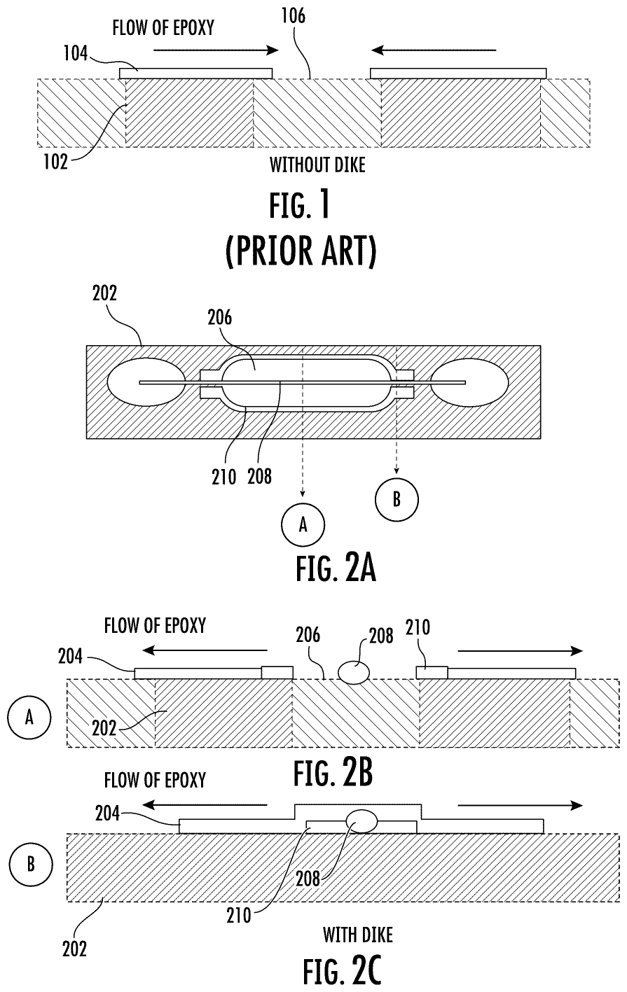

### DETAILED DESCRIPTION

Exemplary embodiments of a dike as an epoxy squeeze out barrier in accordance with the present disclosure will now be described more fully hereinafter with reference made to the accompany drawings. The dike as an epoxy squeeze out barrier may, however, be embodied in many different forms and should not be construed as being limited to the embodiments set forth herein. Rather, these embodiments are provided so that this disclosure will convey certain exemplary aspects of a dike as an epoxy squeeze out barrier to those skilled in the art.

As disclosed herein, the dike as an epoxy squeeze out barrier can be used to prevent epoxy or other adhesive from seeping out from between layers of a laminate material in a fuse device. In particular, in some embodiments, the dike can include a non-conductive, photo-imageable material, coating, mask, or the like, such as a polymer with a flammability of zero, that can be formed around a circumference of a cavity. The cavity can house a fuse element, such as a wire and/or a wire-in-air (WIA), in the fuse device, and the dike can prevent the epoxy, in sheet or liquid form, from flowing into the cavity during a final pressing stage of manufacture, including lamination. In some embodiments, the laminate material can include FR4, and central openings and/or internal cut-outs of the laminate material can form the cavity.

Advantageously, because the dike can prevent the epoxy from seeping out from between the layers of the laminate material, known restrike failure and product reliability issues, including element corrosion and nuisance openings, caused by chemical seep can be eliminated and/or minimized as compared to fuse devises known in the art. Additionally, because the dike can control the epoxy from squeezing out into the cavity, the final pressing stage of manufacture during which the laminate material and the epoxy are pressed together can use a higher pressure range than what has been used in connection with fuse devices known in the art, such as, for example an optimized pressure range that can allow for complete sealing of the laminate material and the epoxy in the fuse device. In some embodiments, processing time of the final pressing stage can be even faster than processing times of the final pressing stage of fuse devices known in the art. Still further, a thicker layer of the epoxy can be used than what has been used in connection with fuse devices known in the art, thereby ensuring full encapsulation of all portions of the fuse element between the laminate material.

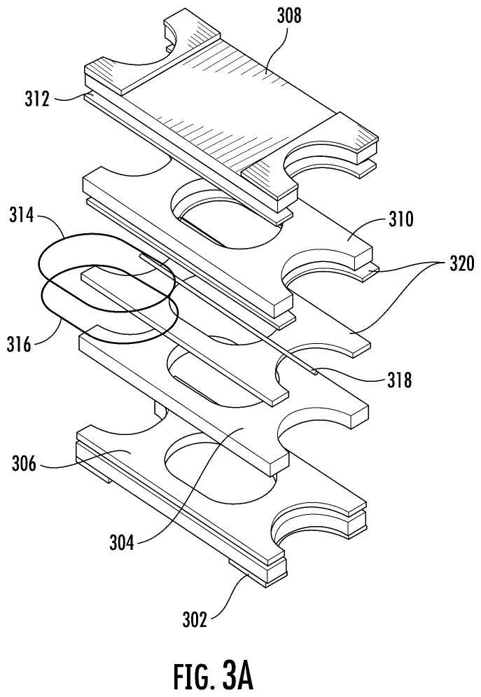

FIG. 2A is a cross-sectional top view illustrating a fuse device in accordance with disclosed embodiments. As seen in FIG. 2A, the fuse device can include at least one layer of a laminate material 202, such as FR4, with a cavity 206 formed by a central opening and/or an internal cut-out of the laminate material 202. A fuse element 208, such as a wire and/or a WIA, can traverse a diameter of the cavity 206 so that a central portion of the fuse element 208 is suspended within the cavity 206 and ends of the fuse element 208 are anchored on or by the laminate material 202. A dike 210 can be located on top of, below, and/or in between layers of the laminate material 202 so that the dike 210 surrounds a circumference of the cavity 206.

FIG. 2B is a cross-sectional side view illustrating the fuse device of FIG. 2A along cross-section A, and FIG. 2C is a cross sectional side view illustrating the fuse device of FIG. 2A along cross-section B. Epoxy 204 can be placed on top of, below, and/or in between layers of the laminate material 202 for bonding thereof. As seen by the arrows in FIG. 2B and FIG. 2C designating the flow of the epoxy 204, the epoxy 204 can flow away from the cavity 206 and the dike 210 when the layers of the laminate material 202 and the epoxy 204 are pressed together during manufacture. In particular, in some embodiments, the dike 210 can prevent the flow of the epoxy 204 into the cavity 206, thereby causing the epoxy 204 to flow away from the cavity 206 during manufacture.

With reference to FIG. 2C, in particular, ends of the fuse element 208 and/or at least some of those portions of the element 208 outside of the cavity and/or not suspended within the cavity 206 can be located on top of, below, and/or in a slot or a canal of the dike 210. In these embodiments, the epoxy 204 can flow over those ends of the fuse element 208 outside of the cavity 206 while the dike 210 still prevents the epoxy 204 from flowing into the cavity 206.

A dike in accordance with disclosed embodiments can be placed on top of, below, and/or in between any layers of a laminate material of a fuse device where the dike can control or prevent epoxy from squeezing out into a cavity formed by the laminate material. For example, in some embodiments, the dike can be placed between layers of the laminate material where a fuse element is embedded. Additionally or alternatively, in some embodiments, the dike can be placed between layers of the laminate material where the epoxy has a predetermined thickness.

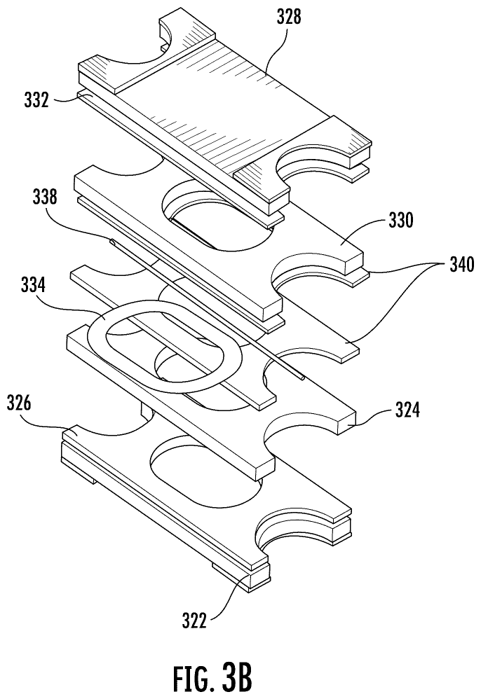

For example, FIG. 3A is an exploded view illustrating a fuse device in accordance with disclosed embodiments. As seen in FIG. 3A, the fuse device can include a bottom layer of laminate material 302 and a bottom middle layer of the laminate material 304 with epoxy 306 therebetween for bonding thereof. That is, the epoxy 306 can bond a top side of the bottom layer of the laminate material 302 to a bottom side of the bottom middle layer of the laminate material 304. The fuse device can also include a top layer of the laminate material 308 and a top middle layer of the laminate material 310 with epoxy 312 therebetween for bonding thereof. That is, the epoxy 312 can bond a bottom side of the top layer of the laminate material 308 to a top side of the top middle layer of the laminate material 310.

At least the top middle layer of the laminate material 310 and the bottom middle layer of the laminate material 304 can include central openings and/or internal cut-outs forming a cavity therein. A fuse element 318, such as a wire and/or a WIA, can be placed between the top middle layer of the laminate material 310 and the bottom middle layer of the laminate material 304 so that the fuse element 318 can traverse a diameter of the cavity so that a central portion of the fuse element 318 is suspended within the cavity and ends of the fuse element 318 are anchored on or by the top middle layer of the laminate material 310 and the bottom middle layer of the laminate material 304.

A first dike 314 can be placed on and/or attached to a bottom side of the top middle layer of the laminate material 310, and a second dike 316 can be placed on and/or attached to a top side of the bottom middle layer of the laminate material 304. The first dike 314 can surround a circumference of the cavity formed by the top middle layer of the laminate material 310, and the second dike 316 can surround a circumference of the cavity formed by the bottom middle layer of the laminate material 304.

In some embodiments, the first dike 314 and/or the second dike 316 can include a photo-imageable material, such as, for example, Vacrel from Dupont, and in some embodiments, the first dike 314 and/or the second dike 316 can have an original thickness on an order of 50.8 microns or 2.5 mils. In some embodiments, the top middle layer of the laminate material 310 and/or the bottom middle layer of the laminate material 304 can include a glass-reinforced epoxy laminate material, such as FR4.

Epoxy 320 can be used to bond the bottom side of the top middle layer of the laminate material 310, the top side of the bottom middle layer of the laminate material 304, the first dike 314, the second dike 316, and the fuse element 318 together. When all of these layers are pressed together during a pressing stage of manufacture, such as a press lamination process, the first dike 314 and the second dike 316 can prevent the epoxy 320 from flowing or seeping into the cavity. Also during the pressing stage of manufacture, the original thickness of the first dike 314, the second dike 316, and the epoxy 320 can be reduced to a reduced thickness that is some thickness lower than the original thickness.

As a further example, FIG. 3B is an exploded view illustrating a fuse device in accordance with disclosed embodiments. As seen in FIG. 3B, the fuse device can include a bottom layer of laminate material 322 and a bottom middle layer of the laminate material 324 with epoxy 326 therebetween for bonding thereof. That is, the epoxy 326 can bond a top side of the bottom layer of the laminate material 322 to a bottom side of the bottom middle layer of the laminate material 324. The fuse device can also include a top layer of the laminate material 328 and a top middle layer of the laminate material 330 with epoxy 332 therebetween for bonding thereof. That is, the epoxy 332 can bond a bottom side of the top layer of the laminate material 328 to a top side of the top middle layer of the laminate material 330.

At least the top middle layer of the laminate material 330 and the bottom middle layer of the laminate material 324 can include central openings and/or internal cut-outs forming a cavity therein. A fuse element 338, such as a wire and/or a WIA, can be placed between the top middle layer of the laminate material 330 and the bottom middle layer of the laminate material 324 so that the fuse element 338 can traverse a diameter of the cavity so that a central portion of the fuse element 338 is suspended within the cavity and ends of the fuse element 338 are anchored on or by the top middle layer of the laminate material 330 and the bottom middle layer of the laminate material 324.

A dike 334 can be placed on, between, and/or attached to a bottom side of the top middle layer of the laminate material 330 and/or a top side of the bottom middle layer of the laminate material 324. When pressed together, the dike 334 can surround a circumference of the cavity formed by the top middle layer of the laminate material 330 and/or the bottom middle layer of the laminate material 324.

In some embodiments, the dike 334 can include a film, such as, for example, Dynamask from Eternal, and in some embodiments, the dike 334 can have an original thickness on an order of 101.6 microns or 4 mils. In some embodiments, the top middle layer of the laminate material 330 and/or the bottom middle layer of the laminate material 324 can include a glass-reinforced epoxy laminate material, such as FR4.

Epoxy 340 can be used to bond the bottom side of the top middle layer of the laminate material 330, the top side of the bottom middle layer of the laminate material 324, the dike 334, and the fuse element 338 together. When all of these layers are pressed together during a pressing stage of manufacture, such as a press lamination process, the dike 334 can prevent the epoxy 340 from flowing or seeping into the cavity. Also during the pressing stage of manufacture, the original thickness of the dike 334 and the epoxy 340 can be reduced to a reduced thickness that is some thickness lower than the original thickness.

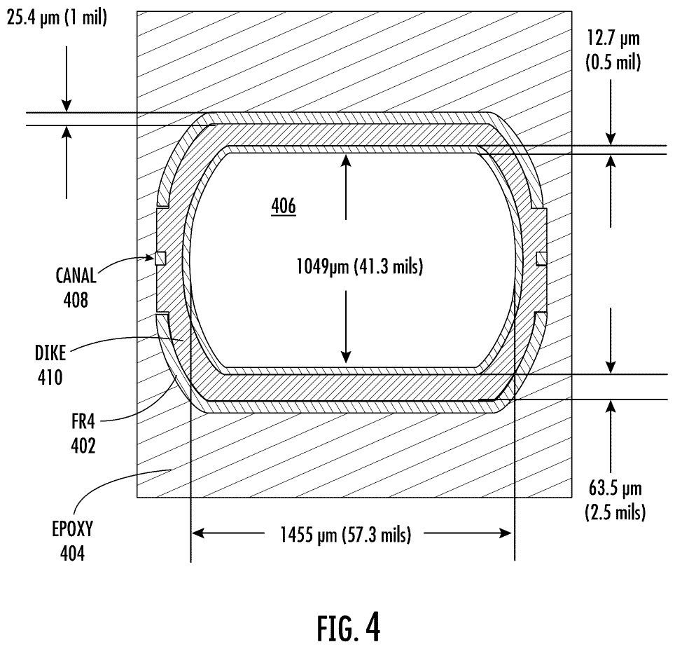

FIG. 4 is a cross-sectional top view illustrating a fuse device in accordance with disclosed embodiments. It is to be understood that while FIG. 4 identifies sizes, measurements, dimensions, and clearances of various elements, those sizes, measurements, dimensions, and clearances are exemplary only. Indeed, sizes, measurements, dimensions, and clearances of various elements of the fuse device can be varied as would be understood by one of ordinary skill in the art.

As seen in FIG. 4, the fuse device can include at least one layer of a laminate material 402, such as FR4, with a cavity 406 formed by a central opening and/or an internal cut-out of the laminate material 402. Epoxy 404 can be placed on top of, below, and/or in between layers of the laminate material 402 for bonding thereof. A dike 410 can also be located on top of, below, and/or in between layers of the laminate material 402 so that the dike 410 surrounds a circumference of the cavity 406. In some embodiments, the fuse device can include a clearance between the epoxy 404 and the dike 410. For example, in some embodiments, this clearance can be on an order of 25.4 microns or 1 mil. Additionally or alternatively, in some embodiments, the fuse device can include a clearance between the cavity 406 and the dike 410. For example, in some embodiments, this clearance can be on an order of 12.7 microns or 0.5 mil. In any embodiment, these clearances relative to the dike 410 can provide room for spreading of the epoxy 404 and/or the dike 410 outside of the cavity 406 when an original thickness of the epoxy 404 and/or the dike 410 is reduced during a pressing stage of manufacture.

In some embodiments, the dike 410 can include a slot or a canal 408 patterned or cut out on portions of opposing ends of the dike 410. In these embodiments, the canal 408 can hold a fuse element, such as a wire, and act as a guide for placing the fuse element relative to the laminate material 402, the cavity 406, and the dike 410.

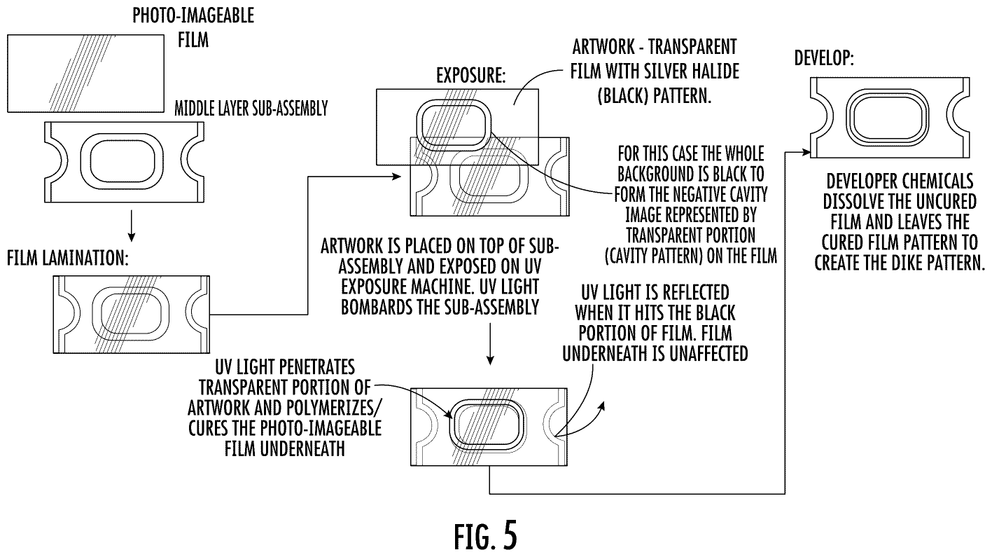

The fuse device as disclosed and described herein can be manufactured in a variety of different manners. For example, when a dike in the fuse device includes a film, the fuse device can be manufactured using a photo-imaging and/or photo-lithography process and method that uses a UV exposure machine and an artwork pattern, an example of which is illustrated in FIG. 5.

As seen in FIG. 5, a sheet of a photo-imageable film can be placed on top of a middle layer of a sub-assembly and laminated thereon. Then, a sheet of a transparent film with the artwork pattern, such as, for example, a silver halide or a black pattern, can be placed on top of the photo-imageable film. In particular, a background of the artwork pattern can include a non-transparent portion to form a negative image represented by a transparent portion of the artwork pattern.

Once the sheet of the transparent film is placed on top of the sheet of the photo-imageable film, the artwork pattern can be exposed. For example, UV light can bombard the transparent film in the UV exposure machine. The UV light can penetrate the transparent portion of the transparent film to polymerize/cure some portions of the photo-imageable film underneath the transparent film while the UV light can be reflected when hitting the non-transparent portion of the transparent film so that other portions of the photo-imageable film underneath can remain unaffected.

Finally, the sheet of the transparent film can be removed, and developer chemicals can be used to dissolve uncured portions of the photo-imageable film while simultaneously leaving the portions of the photo-imageable film that were cured to create the dike.

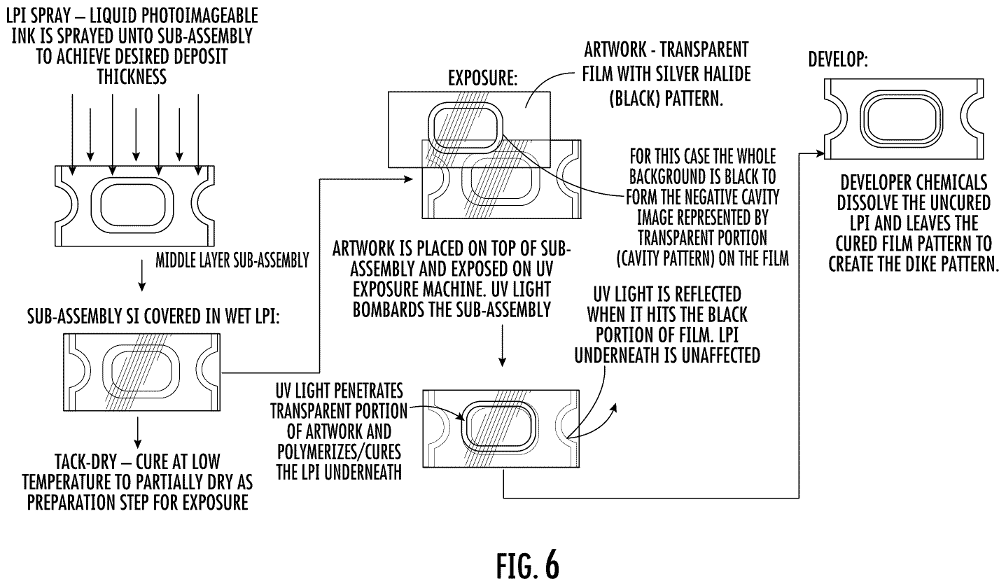

Additionally or alternatively, when a dike in the fuse device includes a liquid photo-imageable ink (LPI) that is sprayable, the fuse device can be manufactured using a photo-imaging and/or photo-lithography process and method that uses a UV exposure machine and an artwork pattern, an example of which is illustrated in FIG. 6.

As seen in FIG. 6, the LPI can be sprayed onto a middle layer of a sub-assembly to achieve a desired deposit thickness. The LPI can be wet, but tack-dried or cured at low temperatures to partially dry in preparation for exposure. Then, a sheet of a transparent film with an artwork pattern, such as, for example, a silver halide or a black pattern, can be placed on top of the LPI. In particular, a background of the artwork pattern can include a non-transparent portion to form a negative image represented by a transparent portion of the artwork pattern.

Once the sheet of the transparent film is placed on top of the LPI, the artwork pattern can be exposed. For example, UV light can bombard the transparent film in the UV exposure machine. The UV light can penetrate the transparent portion of the transparent film to polymerize/cure some portions of the LPI underneath the transparent film while the UV light can be reflected when hitting the non-transparent portion of the transparent film so that other portions of the LPI underneath can remain unaffected.

Finally, the sheet of the transparent film can be removed, and developer chemicals can be used to dissolve uncured portions of the LPI while simultaneously leaving the portions of the LPI that were cured to create the dike.

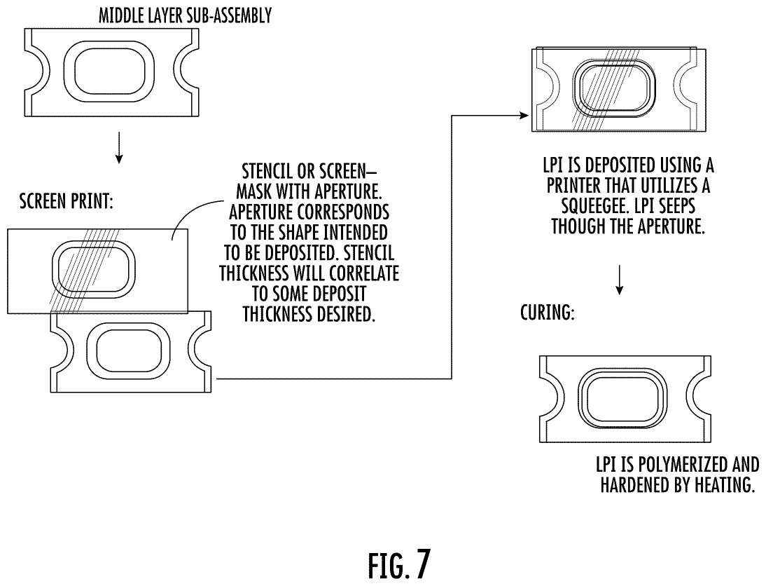

Additionally or alternatively, when a dike in the fuse device includes a screen print or a stencil of the LPI, the fuse device can be manufactured using a printer and a curing machine, an example of which is illustrated in FIG. 7.

As seen in FIG. 7, the screen print or the stencil can be placed on top of a middle layer of a sub-assembly. In particular, the screen print or the stencil can include a mask with an aperture that corresponds to a shape intended to be deposited, and a thickness of the screen print or the stencil can correlate to a desired deposit thickness.

Once the screen print or the stencil is placed on top of the middle layer of the sub-assembly, the LPI can be deposited, for example, using a printer that can utilize a squeegee. In particular, the LPI can seep through the aperture of the screen print or the stencil and onto the middle layer of the sub-assembly.

Finally, the screen print or the stencil can be removed, and LPI can be polymerized/cured via heat, for example, from the curing machine, to create the dike.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. An apparatus comprising:
a first layer of laminate material;
a second layer of the laminate material;
a cavity formed by central openings of the first layer of the laminate material and the second layer of the laminate material;
a fuse element that is supported by at least one of the first layer of the laminate material and the second layer of the laminate material and traverses the cavity;
an adhesive located on at least one of the first layer of the laminate material and the second layer of the laminate material for bonding thereof; and
a dike located on at least one of the first layer of the laminate material and the second layer of the laminate material and surrounding a circumference of the cavity,
wherein when the first layer of the laminate material, the second layer of the laminate material, the fuse element, the adhesive, and the dike are pressed together during manufacture, the dike prevents the adhesive from flowing into the cavity.

2. The apparatus of claim 1 wherein the dike includes a non-conductive material.

3. The apparatus of claim 2 wherein the dike includes a photo-imageable material, a liquid photo-imageable ink, a film, a coating, or a mask.

4. The apparatus of claim 1 wherein the adhesive flows away from the cavity and the dike when the first layer of the laminate material, the second layer of the laminate material, the fuse element, the adhesive, and the dike are pressed together during manufacture.

5. The apparatus of claim 1 wherein the dike includes a slot or a canal on opposing ends of the dike for holding or guiding the fuse element.

6. The apparatus of claim 1 further comprising:
a clearance between the adhesive and the dike or between the cavity and the dike.

7. The apparatus of claim 6 wherein the adhesive material spreads into the clearance when the first layer of the laminate material, the second layer of the laminate material, the fuse element, the adhesive, and the dike are pressed together during manufacture.

8. A method comprising:
supporting a fuse element by at least one of a first layer of laminate material or a second layer of the laminate material with the fuse element traversing a cavity formed by central openings of the first layer of the laminate material and the second layer of the laminate material;
forming a dike on at least one of the first layer of the laminate material or the second layer of the laminate material between the first layer of the laminate material and the second layer of the laminate material with the dike surrounding the cavity;
bonding the first layer of the laminate material and the second layer of the laminate material with an adhesive located on at least one of the first layer of the laminate material and the second layer of the laminate material;
pressing the first layer of the laminate material, the second layer of the laminate material, the fuse element, the adhesive, and the dike together during manufacture; and
preventing the adhesive from flowing into the cavity with the dike.

9. The method of claim 8 further comprising:
flowing the adhesive away from the cavity and the dike.

10. The method of claim 8 further comprising:
holding or guiding the fuse element with a slot or a canal on opposing ends of the dike.

11. The method of claim 8 further comprising:
spreading the adhesive material into a clearance between the adhesive and the dike or between the cavity and the dike.

12. The method of claim 8 further comprising:
lowering an original thickness of the dike or the adhesive material to a reduced thickness.

13. The method of claim 8 further comprising:
placing a photo-imageable film on at least one of the first layer of the laminate material or the second layer of the laminate material;
placing a transparent film with an artwork pattern on the photo-imageable film;
exposing the artwork pattern to cure a portion of the photo-imageable film underneath the transparent film;
removing the transparent film; and
dissolving uncured portions of the photo-imageable film while leaving the portion of the photo-imageable film that was cured to create the dike.

14. The method of claim 8
spraying a liquid photo-imageable ink (LPI) on at least one of the first layer of the laminate material or the second layer of the laminate material;
placing a transparent film with an artwork pattern on the LPI;
exposing the artwork pattern to cure a portion of the LPI underneath the transparent film;
removing the transparent film; and
dissolving uncured portions of the LPI while leaving the portion of the LPI that was cured to create the dike.

15. The method of claim 14 further comprising:
curing the LPI at low temperatures to partially dry the LPI prior to placing the transparent film on the LPI.

16. The method of claim 8 further comprising:
placing a screen print or a stencil on at least one of the first layer of the laminate material or the second layer of the laminate material;
depositing a liquid photo-imageable ink (LPI) on the screen print or the stencil with the LPI seeping through an aperture of the screen print or the stencil and onto at least one of the first layer of the laminate material or the second layer of the laminate material;
removing the screen print or the stencil; and
curing the LPI on the first layer of the laminate material or the second layer of the laminate material to create the dike.

17. An apparatus comprising:
a layer of laminate material;
a cavity formed by an internal cut-out of the layer of the laminate material;
an adhesive located on the layer of the laminate material; and
a dike located on the layer of the laminate material and surrounding a circumference of the cavity,
wherein the dike controls a flow of the adhesive.

18. The apparatus of claim 17 wherein the dike includes a slot or a canal on opposing ends of the dike.

19. The apparatus of claim 17 further comprising:
a clearance between the adhesive and the dike or between the cavity and the dike.

20. The apparatus of claim 17 when the layer of the laminate material, the adhesive, and the dike are pressed together during manufacture, the dike prevents the adhesive from flowing into the cavity.
